(19) United States
(12) Patent Application Publication
(10) Pub. No.: US 2024/0401599 A1
(43) Pub. Date: Dec. 5, 2024

(54) BLOWER

(71) Applicant: FujiClean Co., Ltd., Aichi (JP)

(72) Inventors: Tomoki NAGASAKA, Aichi (JP); Mai DEGUCHI, Aichi (JP)

(73) Assignee: FujiClean Co., Ltd., Aichi (JP)

(21) Appl. No.: 18/698,939

(22) PCT Filed: Sep. 28, 2022
(86) PCT No.: PCT/JP2022/036140

§ 371 Date: Apr. 5, 2024

(30) Foreign Application Priority Data
Oct. 13, 2021 (JP) 2021-168155

(51) Int. Cl. F04D 27/00; F04B 35/04; F04B 53/16; F04D 25/06; F04D 29/40

(52) U.S. Cl. CPC F04D 27/001; F04B 35/04; F04B 53/16; F04D 25/06; F04D 29/403

(57) ABSTRACT

The blower includes a pump and an alarm device. The alarm device has a buzzer, a lamp, a control unit, and a cover fixed to the pump. The cover comprises a plurality of sections including a first cover section and a second cover section, and the buzzer, the lamp, and the control unit are fixed to the first cover section.

### TECHNICAL FIELD

This specification relates to a blower for wastewater treatment apparatus.

### BACKGROUND ART

Conventionally, a blower is connected to a wastewater treatment apparatus. Gas (e.g. air) supplied by the blower is used for a variety of processes. For example, oxygen-containing gas is used for aerobic treatment. The gas agitates water in a water treatment tank included in the wastewater treatment apparatus in order to wash the water treatment tank. The gas drives an air lift pump.

### CITATION LIST

### Patent Literature

Patent Literature 1 Japanese Laid-Open Patent Publication No. 2014-184372
Patent Literature 2 U.S. Pat. No. 4,115,770 Specification

### SUMMARY OF INVENTION

### Technical Problem

If gas is supplied properly from the blower to the wastewater treatment apparatus, the wastewater treatment apparatus can treat wastewater properly. If the supply of gas has a problem, such as gas leakage in a piping for connecting the blower and the wastewater treatment apparatus, or failure of the blower (e.g. breakage of diaphragm), the wastewater treatment is more likely to be inadequate.

This specification discloses a blower with an alarm device configured to inform of a problem.

### Solution to Problem

The technique disclosed herein can be implemented as any of application examples listed below.

### Application Example 1

A blower for wastewater treatment apparatus including:
a pump configured to output oxygen-containing gas; and
an alarm device fixed to the pump, wherein
the alarm device has:
   a buzzer;
   a lamp;
   a control unit configured to control the buzzer and the lamp depending on a pressure of gas to be output by the pump; and
   a cover fixed to the pump,
the cover has an inner surface to form an internal space surrounded by the inner surface,
the cover houses the buzzer and the control unit within the internal space,
the cover comprises a plurality of sections including a first cover section and a second cover section, and
the buzzer, the lamp, and the control unit are fixed to the first cover section.

According to this configuration, because the buzzer, the lamp, and the control unit are fixed to the common first cover section, the complexity of manufacture of the blower with the alarm device is reduced as compared with when the buzzer, the lamp, and the control unit are distributed between two or more cover sections.

### Application Example 2

The blower according to Application Example 1, wherein
the buzzer has:
   an oscillator;
   a drive device configured to oscillate the oscillator; and
   a first beaten element configured to be beaten repeatedly by the oscillating oscillator to produce a first buzzer sound,
the alarm device has a second beaten element configured to be beaten repeatedly by the oscillating buzzer to produce a second buzzer sound when the drive device oscillates the oscillator.

According to this configuration, the alarm device can produce a larger sound including the first buzzer sound and the second buzzer sound.

### Application Example 3

A blower for wastewater treatment apparatus including:
a pump configured to output oxygen-containing gas; and
an alarm device fixed to the pump, wherein
the alarm device has:
   a buzzer;
   a control unit configured to control the buzzer depending on a pressure of gas to be output by the pump; and
   a cover fixed to the pump,
the cover has an inner surface to form an internal space surrounded by the inner surface,
the cover houses the buzzer and the control unit within the internal space, the buzzer has:
   an oscillator;
   a drive device configured to oscillate the oscillator; and
   a first beaten element configured to be beaten repeatedly by the oscillating oscillator to produce a first buzzer sound,
the alarm device has a second beaten element configured to be beaten repeatedly by the oscillating buzzer to produce a second buzzer sound when the drive device oscillates the oscillator.

According to this configuration, the alarm device can produce a larger sound including the first buzzer sound and the second buzzer sound.

### Application Example 4

The blower according to Application Example 2 or 3, wherein
the alarm device has a projection projecting toward the buzzer, and
an end of the projection forms the second beaten element.

According to this configuration, the second beaten element can be formed readily.

### Application Example 5

The blower according to any one of Application Examples 2 to 4, wherein
the alarm device has a first forming element forming the second beaten element,
the first forming element comprises one or more members separate from the cover, and
the first forming element is fixed to the cover.

According to this configuration, if the second beaten element is damaged, the first forming element can be replaced without replacing the cover.

### Application Example 6

The blower according to Application Example 5, wherein
the cover has a recess forming element that forms a recess provided on the internal space side of the cover,
the first forming element includes a first portion located within the recess and a second portion exposed to the internal space, and
the second portion forms the second beaten element.

According to this configuration, the complexity of manufacture of the blower with the second beaten element is reduced.

### Application Example 7

The blower according to any one of Application Examples 2 to 6, wherein
the second beaten element includes a flat outer surface, and
the buzzer and the second beaten element are arranged such that the buzzer beats the flat outer surface of the second beaten element.

According to this configuration, the change in location of the buzzer due to the second beaten element being beaten is reduced as compared with when a curved outer surface is beaten by the buzzer.

### Application Example 8

The blower according to any one of Application Examples 1 to 7, wherein
the buzzer has a first member with a through hole, and
the alarm device has:
   a fixing element that fixes the buzzer to the cover by passing through the through hole of the first member; and
   a position restricting element that restricts a rotational position of the buzzer about the through hole by coming contact with the buzzer.

According to this configuration, the deviation of rotational position of the buzzer is reduced.

### Application Example 9

The blower according to Application Example 8, wherein
the position restricting element restricts the rotational position of the buzzer by coming into contact with the first member of the buzzer.

According to this configuration, the position restricting element can restrict the rotational position of the buzzer.

### Application Example 10

The blower according to any one of Application Examples 1 to 9, wherein
the cover has a lower wall which is a lower wall of the alarm device, and
the lower wall has a thorough hole.

According to this configuration, the alarm device can output a larger sound because the sound produced by the alarm device is output through the through hole from the inside to the outside of the cover. In addition, rainwater is less likely to enter the inside of the cover through the through hole because the lower wall has the through hole.

It should be noted that the techniques disclosed in this specification can be realized in a variety of aspects, for example, a blower, a wastewater treatment apparatus with blower and water treatment tank, etc.

### BRIEF DESCRIPTION OF DRAWINGS

FIG. 1 is an explanatory diagram showing an embodiment of wastewater treatment system;

FIGS. 2(A), (B) are perspective views of the blower 30;

FIG. 3 is a schematic diagram of the blower 30;

FIGS. 4(A)-(F) are schematic diagrams illustrating the configuration inside of the recess 387 of the first cover section 300 and the configuration of a buzzer 500;

FIGS. 5(A)-(D) are schematic diagrams illustrating the operation of the buzzer 500;

FIG. 6 is a schematic diagram of the electrical configuration of the blower 30;

FIGS. 7(A), (B) are schematic diagrams illustrating an embodiment of the pressure switch 600;

FIG. 8 is a table that shows correspondence relationships among the connection state of the switch 700, the operation mode of the alarm device 200, and the state of the alarm device 200;

FIG. 9 is a flowchart showing an example manufacturing method of the blower 30;

FIG. 10 is a schematic diagram showing another embodiment of alarm device;

FIG. 11(A) is a schematic diagram showing another embodiment of alarm device;

FIG. 11(B) is a schematic diagram illustrating the configuration inside of a recess 387c of the first cover section 300c; and

FIG. 12 is a schematic diagram showing another embodiment of alarm device.

### DESCRIPTION OF EMBODIMENTS

### A. First Embodiment

### A1. Configuration of Wastewater Treatment System:

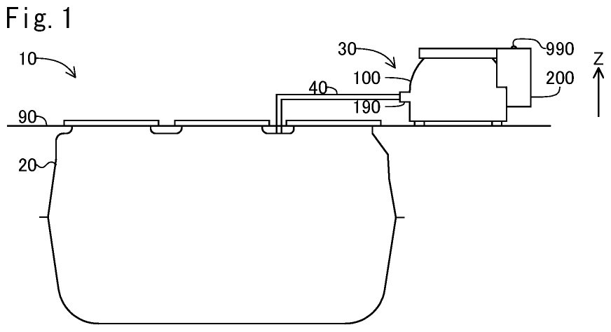

FIG. 1 is an explanatory diagram showing an embodiment of wastewater treatment system. The wastewater treatment system 10 of this embodiment has a wastewater treatment apparatus 20, and a blower 30 connected via a connecting pipe 40 to the wastewater treatment apparatus 20. The blower 30 supplies air, which is an example of oxygen-containing gas, via the connecting pipe 40 to the wastewater treatment apparatus 20.

The wastewater treatment apparatus 20 performs a purification process on wastewater from a general household etc. (Such device is also referred to as a “septic tank.”) The wastewater treatment apparatus 20 may have one or more various water treatment tanks. In this embodiment, the wastewater treatment apparatus 20 has a foreign matter removal tank, an anaerobic treatment tank, an aerobic treatment tank, a treated water tank, and a disinfection tank, although not shown in this figure. The wastewater is processed in the above order by these water treatment tanks. The foreign matter removal tank separates solids in the wastewater. The anaerobic treatment tank performs an anaerobic treatment with anaerobic microorganisms. The aerobic treatment tank performs an aerobic treatment with aerobic microorganisms. The treated water tank temporarily stores the water from the aerobic treatment tank. The disinfection tank disinfects the water from the treated water tank.

The wastewater treatment apparatus 20 may have a variety of devices which operate using air from the blower 30. In this embodiment, the wastewater treatment apparatus 20 has an aeration device disposed in the aerobic treatment tank, and an air lift pump which transfers water from the treated water tank to the foreign matter removal tank (not shown). The aeration device discharges air from the blower 30 into water. This causes oxygen to be supplied to the water. The aerobic microorganisms use the oxygen in the water to perform aerobic treatment. The air lift pump uses the air from the blower 30 to transfer the water from the treated water tank to the foreign matter removal tank. This causes the water to circulate through the plurality of water treatment tanks. Within the wastewater treatment apparatus 20, a pipe connected to the connecting pipe 40 is branched to a pipe connected to the aeration device and to a pipe connected to the air lift pump.

It should be noted that the wastewater treatment apparatus 20 is buried under ground 90 in FIG. 1. Instead, the wastewater treatment apparatus 20 may be installed on the ground.

In order for the wastewater treatment apparatus 20 to properly treat water, it is preferable that the blower 30 properly supplies air to the wastewater treatment apparatus 20. If the supply of air has a problem (due to breakage of the connecting pipe 40, or failure of the blower 30 (e.g. breakage of diaphragm), etc.), the wastewater treatment is more likely to be inadequate. The blower 30 of this embodiment has an alarm device 200 configured to inform of air supply failure, in addition to a pump 100 configured to output air.

### A2. Configuration of Blower 30;

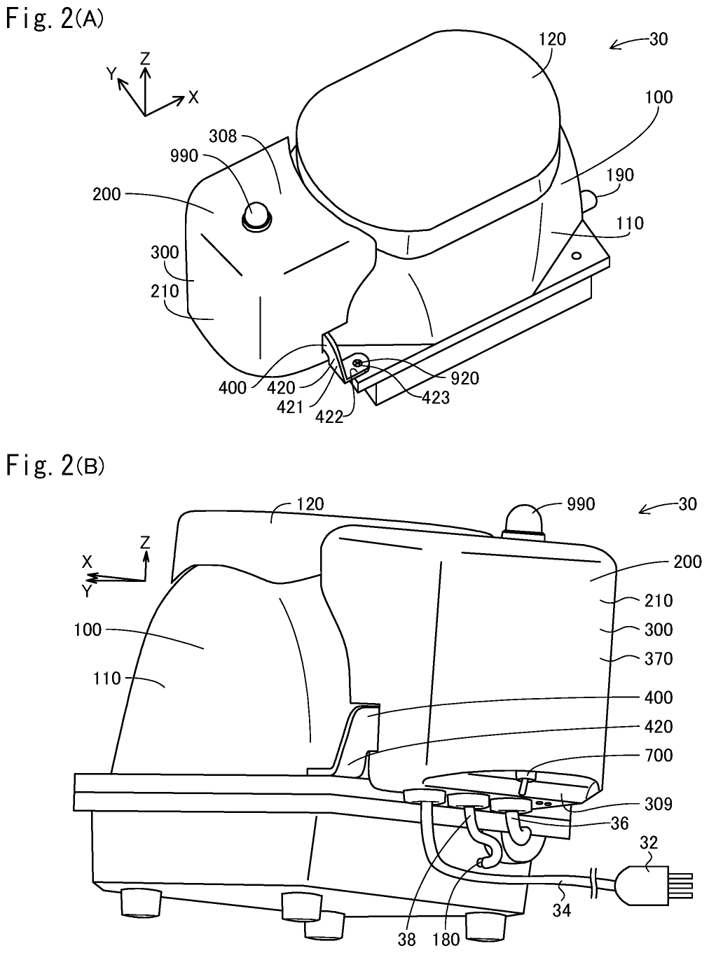

FIG. 2(A), FIG. 2(B) are perspective views of the blower 30. In these figures, directions X, Y, Z related in advance to the blower 30 are shown that are perpendicular to each other. If the blower 30 is installed on a horizontal surface (e.g. horizontal ground), the first direction X and second direction Y are horizontal directions, and the third direction Z is a vertically upward direction. Hereinafter, the third direction Z may be referred to as upward direction Z. In addition, the direction X may be referred to as +X direction, and the direction opposite to the direction X may be referred to as −X direction. This is also applicable to +Y direction, −Y direction, +Z direction, −Z direction.

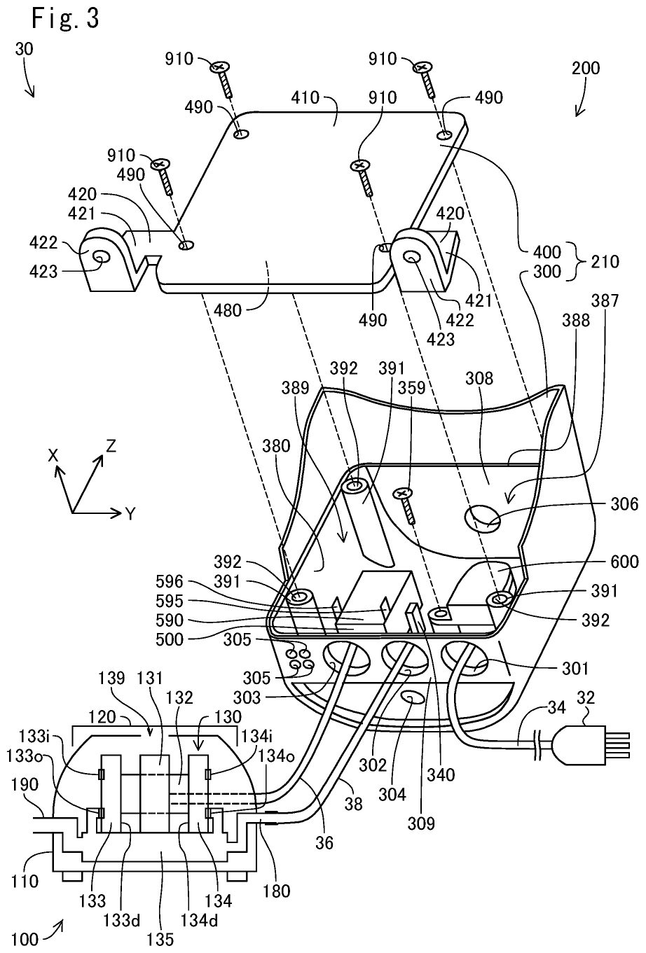

FIG. 3 is a schematic diagram of the blower 30. The lower left portion of the figure schematically shows the internal configuration of the pump 100 as viewed from the side. An exploded perspective view of alarm device 200 is shown to the upper right of the pump 100 in this figure. This figure omits to show wiring in the alarm device 200.

The configuration of the pump 100 may be the same as those of publicly known blowers without any alarm device, except that a flexible tube 38 as described later is provided. In this embodiment, the pump 100 is a diaphragm pump. The pump 100 has a metal case 110. A discharge outlet 190 is provided in the lateral surface on the first direction X side of the case 110 (FIG. 2(A)). A connecting port 180 is provided in the lateral surface on the −X direction side of the case 110 (FIG. 2(B)). A cover 120 is attached to the upward direction Z side of the case 110. The case 110 (FIG. 3) has an air inlet 139 located below the cover 120. A filter (not shown) which covers the air inlet 139 is disposed under the cover 120.

The pump 100 (FIG. 3) has a gas output device 130 contained in the case 110. The gas output device 130 has a solenoid 131, an oscillator 132, two pressure chambers 133, 134, and a tank 135. Attached to the pressure chambers 133, 134 are diaphragms 133d, 134d, air intake valves 133i, 134i, and discharge valves 1330, 1340, respectively. The pressure chambers 133, 134 are made of a resin (e.g. polybutylene terephthalate). The diaphragms 133d, 134d, and valves 133i, 134i, 1330, 1340 are formed of an elastic body (e.g. rubber). Fixed to the oscillator 132 is a permanent magnet (not shown).

The solenoid 131 uses electric power externally supplied (AC voltage in this embodiment) to oscillate the oscillator 132. The oscillation of the oscillator 132 causes the diaphragms 133d, 134d to oscillate. This repeatedly increases and decreases the volumes of the pressure chambers 133, 134. As the volumes of the pressure chambers 133, 134 increase, the pressure chambers 133, 134 suction air through the air inlet 139 and the air intake valve 133i, 134i from outside of the blower 30. As the volumes of the pressure chambers 133, 134 decrease, the pressure chambers 133, 134 output air through the discharge valve 1330, 1340 to the tank 135. The discharge outlet 190 is connected to the tank 135. The air in the tank 135 is discharged through the discharge outlet 190 out of the blower 30. The connecting port 180 is also connected to the tank 135. The flexible tube 38 as described later is connected to the connecting port 180.

The alarm device 200 (FIG. 3) has a cover 210. The cover 210 has a first cover section 300 shaped like a container which forms a recess 387 depressed to the −X direction, and a second cover section 400 which closes an opening 388 of the first cover section 300. The first cover section 300 is made of a resin (polycarbonate in this embodiment). The second cover section 400 is made of a metal (aluminum in this embodiment).

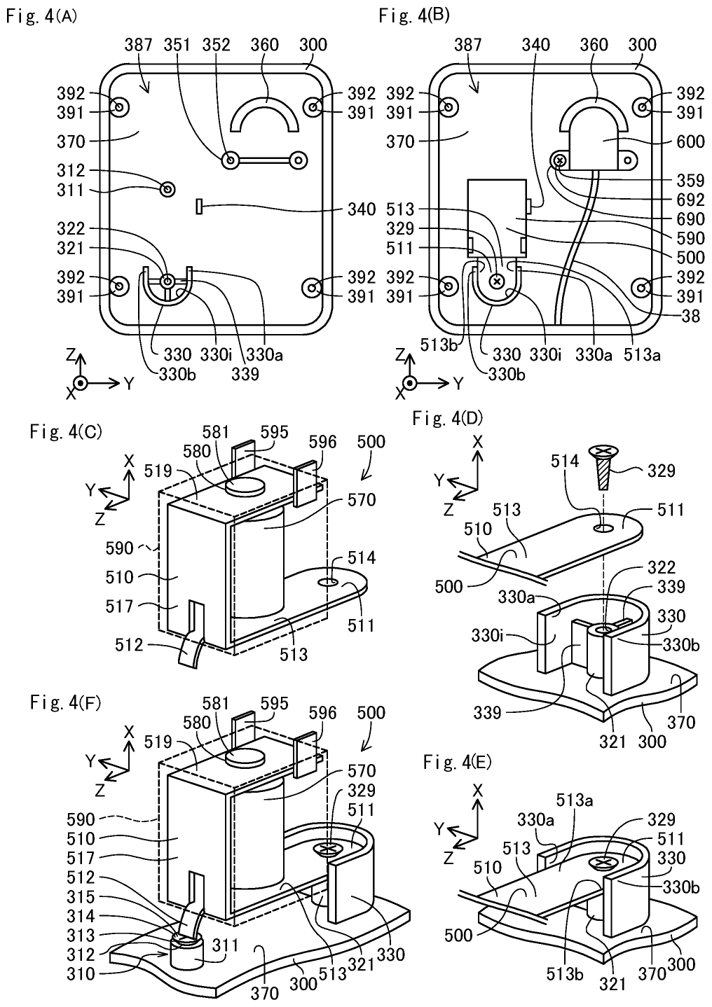

FIG. 4(A)-FIG. 4(F) are schematic diagrams illustrating the configuration inside of the recess 387 of the first cover section 300 and the configuration of a buzzer 500. FIG. 4(A), FIG. 4(B) show the configuration inside of the recess 387 of the first cover section 300. These figures show the first cover section 300 as viewed in the −X direction. A wall 370 (referred to as side wall 370) on the −X direction side of the first cover section 300 forms a bottom of the recess 387. As shown in FIG. 4(B), the buzzer 500 and a pressure switch 600 are fixed to the side wall 370. In addition, a lamp 990 and a switch 700 are fixed to the first cover section 300 (FIG. 2(B)).

### A3. Arrangement of Buzzer 500:

FIG. 4(C) is a schematic diagram of the buzzer 500. This figure shows a perspective view of the buzzer 500. The buzzer 500 has a base member 510, and a case 590 fixed to the base member 510. In this figure, the case 590 is shown by a dotted line, and the buzzer 500 as seen through the case 590 is shown by a solid line.

The base member 510 is a U-shaped metal plate. The base member 510 has a first base portion 513 located on the −X direction side (on the lower side of the figure), a second base portion 517 which extends in the +X direction from the end on the +Z direction side (on the left side of the figure) of the first base portion 513, and a third base portion 519 which extends in the −Z direction from the end of the second base portion 517 on the +X direction side. A through hole 514 is formed in the end 511 (sometimes referred to as first portion 511) on the −Z direction side of the first base portion 513. In addition, a projection 512 projecting in the −X direction is connected to the junction between the first base portion 513 and the second base portion 517. The projection 512 is formed by bend a part of the second base portion 517 in the −X direction.

A cylindrical coil 570 extending in the +X direction is disposed between the first base portion 513 and the third base portion 519. The coil 570 is fixed to the base member 510 via an insulating member (not shown). The buzzer 500 also has an oscillator 580. Although not illustrated, a through hole through which the oscillator 580 extends is provided in the third base portion 519. Accordingly, the oscillator 580 extends from the +X direction side of the third base portion 519 through the through hole of the third base portion 519 and a thorough hole on the inner circumferential side of the coil 570 to the −X direction side of the coil 570.

Two terminals 595, 596 are fixed to the third base portion 519 via insulators (not shown). These terminals 595, 596 are connected to the coil 570. As shown in FIG. 3, each terminal 595, 596 is exposed to the outside of the case 590. The coil 570 (FIG. 4(C)) uses electric power (AC voltage in this embodiment) supplied to the terminals 595, 596 to oscillate the oscillator 580 parallel to the first direction X. A permanent magnet may be fixed to the oscillator 580. As described later, when the oscillator 580 oscillates, the third base portion 519 is beaten repeatedly by the oscillating oscillator 580 to produce a buzzer sound (sometimes referred to as first buzzer sound).

FIG. 4(D), FIG. 4(E) each shows a perspective view of the buzzer 500 and the side wall 370 of the first cover section 300. A first fixing boss 321 is formed on the +X direction side (i.e. inside) of the side wall 370. FIG. 4(D), FIG. 4(E) each shows a portion of the base member 510 of the buzzer 500, the first fixing boss 321, and a portion of the side wall 370. FIG. 4(D) shows an exploded perspective view. As shown, the first fixing boss 321 has a circular cylindrical shape extending in the +X direction from the side wall 370. A threaded hole 322 is formed that extends in the −X direction from the end on the +X direction side of the first fixing boss 321. The first base portion 513 is fixed to the first fixing boss 321 by threading a screw 329 into the threaded hole 322 of the first fixing boss 321 through the through hole 514 of the first portion 511 of the buzzer 500 (the outer diameter of the screw head of the screw 329 is larger than the inner diameter of the through hole 514). Thereby, the buzzer 500 is fixed to the first cover section 300.

As shown in FIG. 4(A), FIG. 4(D), FIG. 4(E), a wall 330 surrounding the first fixing boss 321 is formed on the side wall 370 of the first cover section 300. The wall 330 has a U-shape extending in the +X direction from the side wall 370. In this embodiment, the fixing boss 321 and the wall 330 are connected via a plurality of plates 339. As shown in FIG. 4(D), the wall 330 has a height larger than that of the first fixing boss 321 (these heights are measured in the +X direction from the side wall 370). That is, the wall 330 extends further in the +X direction than the first fixing boss 321 does. In FIG. 4(B), a surface 330i on the inner circumferential side (in this case, the first fixing boss 321 side) of the wall 330 has approximately the same shape as that of the edge of the first portion 511 of the first base portion 513. As shown in FIG. 4(B), FIG. 4(E), the first base portion 513 is fixed to the first fixing boss 321 with the first portion 511 of the first base portion 513 fitted in the inner circumference of the wall 330.

In this embodiment, the buzzer 500 is fixed to the first fixing boss 321 (i.e. the first cover section 300) by the single screw 329. In this case, the buzzer 500 can rotate about the through hole 514 of the first portion 511. In this embodiment, the wall 330 restricts the rotation of the first base portion 513 (and thus the buzzer 500) by coming into contact with the edge of the first base portion 513. For example, in FIG. 4(B), when the buzzer 500 is about to rotate clockwise, a portion 330a on the +Y direction side of the wall 330 prevents the buzzer 500 from rotating by coming into contact with the edge 513a on the +Y direction side of the first base portion 513. When the buzzer 500 is about to rotate counterclockwise, a portion 330b on the −Y direction side of the wall 330 prevents the buzzer 500 from rotating by coming into contact with the edge 513b on the −Y direction side of the first base portion 513. In this manner, the wall 330 restricts the rotational position of the buzzer 500 about the through hole 514 by coming into contact with the buzzer 500.

As shown in FIG. 4(A), FIG. 4(B), a boss 340 located in the +Y direction of the buzzer 500 is formed on the side wall 370 of the first cover section 300. The boss 340 has a rectangular parallelepiped shape extending in the +X direction from the side wall 370. In FIG. 4(B), when the buzzer 500 is about to rotate clockwise, the boss 340 prevents the buzzer 500 from rotating by coming into contact with the surface on the +Y direction side of the case 590 of the buzzer 500. In this manner, the boss 340 restricts the rotational position of the buzzer 500 about the through hole 514 (FIG. 4(D)) by coming into contact with the buzzer 500.

FIG. 4(F) shows a perspective view of the buzzer 500 and the side wall 370 of the first cover section 300. A boss 311 for producing a buzzer sound different from the first buzzer sound described above is formed on the side wall 370 (hereinafter, the boss 311 may be referred to as sound boss 311). The sound boss 311 has a circular cylindrical shape extending in the +X direction from the side wall 370. A threaded hole 312 (FIG. 4(A)) is formed that extends in the −X direction from the end on the +X direction side of the sound boss 311.

FIG. 4(F) shows the buzzer 500, the first fixing boss 321, the wall 330, the sound boss 311, and a portion of the side wall 370. As shown, a screw 313 is threaded in the threaded hole 312 of the sound boss 311. In this embodiment, the screw 313 has a screw head 314 forming a flat top surface 315. In this embodiment, the screw 313 is a flat head screw. A slot for engaging with a tip of screwdriver is formed in the top surface 315. The screw 313 is made of a metal (e.g. stainless steel). With the buzzer 500 fixed to the first fixing boss 321, the projection 512 of the buzzer 500 is in contact with the top surface 315 of the screw 313. The sound boss 311 and the screw 313 collectively form a projection 310 projecting toward the buzzer 500.

### A4. Operation of Buzzer 500:

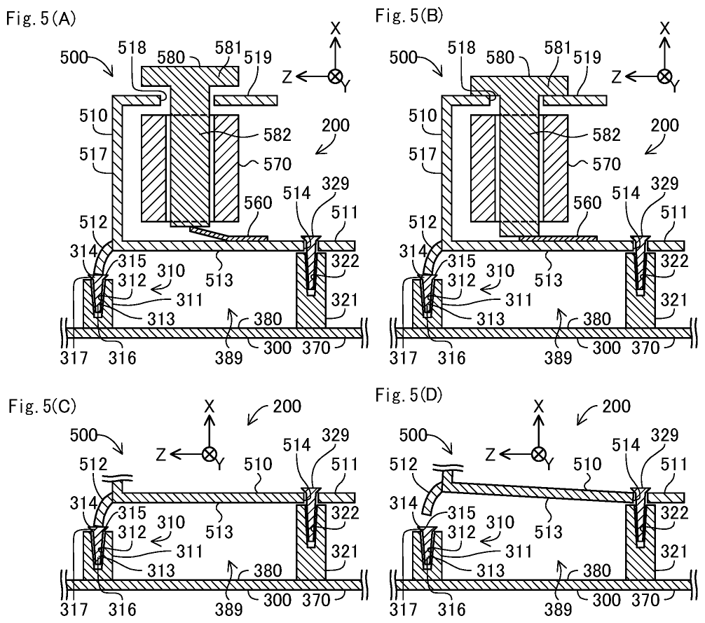

FIG. 5(A)-FIG. 5(D) are schematic diagrams illustrating the operation of the buzzer 500. These figures show cross-sectional views perpendicular to the second direction Y of a portion of the first cover section 300 and a portion of the buzzer 500.

FIG. 5(A), FIG. 5(B) show the configuration of the buzzer 500. A through hole 518 through which the oscillator 580 extends is formed in the third base portion 519 of the base member 510. The oscillator 580 has a first portion 581 located in the +X direction (on the upper side of the figure) of the third base portion 519, and a second portion 582 coupled on the −X direction side of the first portion 581. The first portion 581 has a circular disc shape perpendicular to the first direction X. The second portion 582 extends from the first portion 581 through the through hole 518 and the thorough hole on the inner circumferential side of the coil 570 to the −X direction side of the coil 570. The second portion 582 has a circular cylindrical shape extending in the first direction X. The outer diameter of the first portion 581 is larger than the outer diameter of the second portion 582 and larger than the inner diameter of the through hole 518. A flat spring 560 is disposed between the second portion 582 and the first base portion 513. The flat spring 560 exerts a force in the +X direction on the second portion 582.

When an AC voltage is applied to the coil 570, the coil 570 oscillates the oscillator 580 parallel to the first direction X. FIG. 5(A) shows the state in which the oscillator 580 has moved in the +X direction while FIG. 5(B) shows the state in which the oscillator 580 has moved in the −X direction. In FIG. 5(A), the first portion 581 of the oscillator 580 is away from the third base portion 519. In FIG. 5(B), the first portion 581 is in contact with the third base portion 519. As the oscillator 580 oscillates, the state repeatedly alternates between that of FIG. 5(A) and that of FIG. 5(B). The first portion 581 of the oscillator 580 beats repeatedly the third base portion 519. This causes the first buzzer sound to be produced. Hereinafter, the third base portion 519 may be referred to as first beaten element 519.

FIG. 5(C), FIG. 5(D) illustrate the operation of the buzzer 500 from another perspective. When the oscillator 580 (FIG. 5(A), FIG. 5(B)) oscillates, the coil 570, which exerts the force for oscillation on the oscillator 580, can oscillate due to reaction. The oscillation of the coil 570 causes the base member 510 coupled to the coil 570 to oscillate. In this embodiment, the first portion 511 of the base member 510 is fixed to the first fixing boss 321. A portion of the base member 510 that is away from the first portion 511 can oscillate. In this embodiment, the projection 512 oscillates as the oscillator 580 oscillates. For example, one or both of the first base portion 513 and the first cover section 300 (e.g. first fixing boss 321) deform, and thereby the projection 512 oscillates.

FIG. 5(C) shows the state in which the projection 512 has moved in the −X direction while FIG. 5(D) shows the state in which the projection 512 has moved in the +X direction. In FIG. 5(C), the projection 512 is in contact with the top surface 315 of the screw 313. In FIG. 5(D), the projection 512 is away from the screw 313. As the projection 512 oscillates, the state repeatedly alternates between that of FIG. 5(C) and that of FIG. 5(D). The projection 512 beats repeatedly the top surface 315 of the screw 313. This causes the second buzzer sound to be produced. Hereinafter, the top surface 315 may be referred to as second beaten element 315.

### A5. Arrangement of Pressure Switch 600:

As shown in FIG. 4(A), a second fixing boss 351 is formed on the +X direction side (i.e. inside) of the side wall 370 of the first cover section 300. The second fixing boss 351 has a circular cylindrical shape extending in the +X direction from the side wall 370. A threaded hole 352 is formed that extends in the −X direction from the end on the +X direction side of the second fixing boss 351. As shown in FIG. 4(B), the pressure switch 600 has a projection 690 for fixing. The projection 690 has a thorough hole 692. The projection 690 is fixed to the second fixing boss 351 by threading a screw 359 into the threaded hole 352 of the second fixing boss 351 through the through hole 692. Thereby, the pressure switch 600 is fixed to the first cover section 300.

A wall 360 for positioning the pressure switch 600 is formed on the side wall 370 of the first cover section 300. The wall 360 has contact with the pressure switch 600 to prevent the pressure switch 600 from being misaligned.

### A6. First Cover Section 300 and Second Cover Section 400:

As shown in FIG. 4(A), four third fixing bosses 391 are formed on the +X direction side (i.e. inside) of the side wall 370 of the first cover section 300. The third fixing boss 391 has a circular cylindrical shape extending in the +X direction from the side wall 370. A threaded hole 392 is formed that extends in the −X direction from the end on the +X direction side of the third fixing boss 391.

As shown in FIG. 3, the second cover section 400 has a plate 410, which is a flat plate perpendicular to the first direction X, and two legs 420. The two legs 420 are coupled to the end on the +Y direction side and the end on the −Y direction side of the plate 410, respectively. The plate 410 is a rectangular plate with rounded corners. A through hole 490 is provided near each of the four corners of the plate 410. The four third fixing bosses 391 of the first cover section 300 correspond to the four through holes 490, respectively. The second cover section 400 is fixed to the first cover section 300 by threading a screw 910 into the threaded hole 392 of the third fixing boss 391 through the through hole 490.

The plate 410 of the second cover section 400 (FIG. 3) has an inner surface 480, which is a surface on the first cover section 300 side. The first cover section 300 has an inner surface 380 forming the recess 387. The first cover section 300 and the second cover section 400 form an internal space 389 surrounded by the inner surfaces 380, 480. The buzzer 500 and the pressure switch 600 are housed within the internal space 389.

Each leg 420 of the second cover section 400 has a first portion 421 extending to the −Z direction, and a second portion 422 extending to the +X direction from the end on the −Z direction side of the first portion 421. A through hole 423 is provided in the second portion 422. As shown in FIG. 2(A), the second cover section 400 (and thus the alarm device 200) is fixed to the case 110 of the pump 100 by a screw 920 passing through the through hole 423. It should be noted that in FIG. 2(A), the leg 420 on the +Y direction side is hidden behind the first cover section 300. Although not illustrated, this leg 420 is also fixed to the case 110 by a screw 920 passing through the through hole 423.

### A7. Arrangement of Lamp 990:

As shown in FIG. 3, a through hole 306 is formed in the upper wall 308, which is a wall on the upward direction Z side of the first cover section 300. The lamp 990 (FIG. 2(A)) is fixed to the through hole 306. The lamp 990 has a light emitting device (e.g. LED, light bulb, etc.). The lamp 990 may be fixed in any configuration. Although not shown, the lamp 990 has a male thread for fixing in this embodiment. The lamp 990 is inserted into the through hole 306 from the outside of the first cover section 300. In the first cover section 300, a nut is engaged with the male thread of the lamp 990. Thereby, the lamp 990 is fixed to the first cover section 300.

### A8. Arrangements of Electrical Cord 34, 36, Flexible Tube 38, Switch 700, and Through Hole 305:

A lower wall 309, which is a wall on the −Z direction side (i.e. downward direction side) of the first cover section 300 (FIG. 3), is provided with four through holes 301, 302, 303, 304, and a plurality of through holes 305. A first electric cord 34 connected to an electric plug 32 is inserted in the first through hole 301. A flexible tube 38 connected to the tank 135 of the pump 100 is inserted in the second through hole 302. The flexible tube 38 is made of rubber, for example. A second electric cord 36 connected to the gas output device of the pump 100 is inserted in the third through hole 303. A fixing member (not shown) is attached to each of the through holes 301, 302, 303.

A switch 700 (FIG. 2(B)) is fixed to the fourth through hole 304. The switch 700 may be fixed in any configuration. Although not shown, the switch 700 has a male thread for fixing in this embodiment. The switch 700 is inserted into the fourth through hole 304 from the inside of the first cover section 300. Outside the first cover section 300, a nut of cap with nut is engaged with the male thread of the switch 700. Thereby, the switch 700 is fixed to the first cover section 300.

The plurality of through holes 305 (FIG. 3) lead a sound produced by the alarm device 200 from the inside to the outside of the cover 210.

### A9. Electrical Configuration:

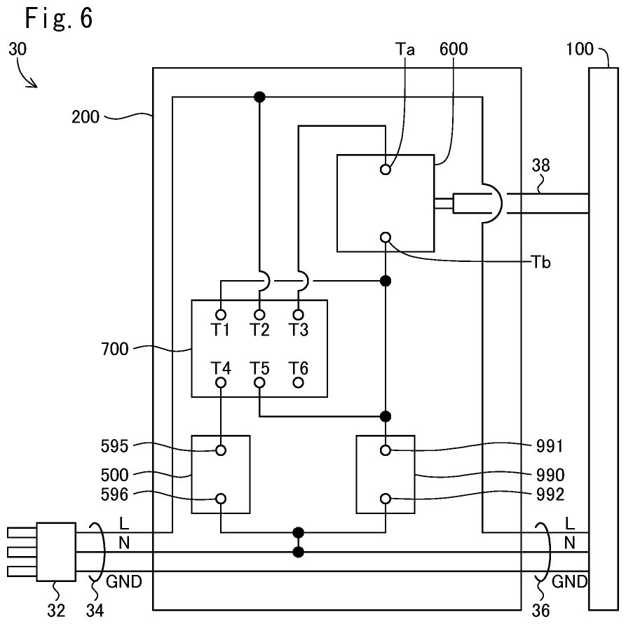

FIG. 6 is a schematic diagram of the electrical configuration of the blower 30. The second electric cord 36 and the flexible tube 38 from the pump 100, and the first electric cord 34 from the electric plug 32 are connected to the alarm device 200. In this embodiment, the electric plug 32 and the electric cord 34, 36 support a single-phase AC power supply, and have a voltage line L (sometimes referred to as Live), a neutral line N, and a grounding line GND (sometimes referred to as earth).

The switch 700 has six terminals T1-T6. The switch 700 is a manual switch (e.g. toggle switch) for selecting one state from among three connection states described later. The lamp 990 has two terminals 991, 992.

The pressure switch 600 has two terminals Ta, Tb. The flexible tube 38 is connected to the pressure switch 600. The pressure switch 600 switches the connection state between terminals Ta, Tb depending on a pressure of air to be supplied by the flexible tube 38. In this embodiment, the pressure switch 600 connects the terminals Ta, Tb if the pressure is lower than a threshold. The pressure switch 600 disconnects the path between the terminals Ta, Tb if the pressure is not lower than the threshold.

In this embodiment, the discharge outlet 190 (FIG. 3) and the connecting port 180 are connected to the tank 135, and the flexible tube 38 is connected to the connecting port 180. That is, the flexible tube 38 is in communication with the discharge outlet 190. The pressure of air to be supplied by the flexible tube 38 is approximately the same as that of air at the discharge outlet 190. Therefore, the connection state between the terminals Ta, Tb is changed depending on the pressure at the discharge outlet 190.

When the supply of air by the blower 30 has a problem such as breakage of the connecting pipe 40 (FIG. 1) or breakage of one or both of diaphragms 133d, 134d (FIG. 3), etc.), the pressure of air at the discharge outlet 190 decreases as compared with when the supply of air has no problem. The threshold of pressure is experimentally determined such that the pressure is not lower than the threshold in the absence of problem while the pressure is lower than the threshold in the presence of problem.

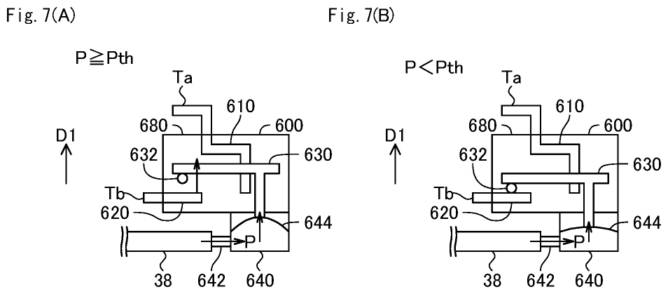

The pressure switch 600 may have any configuration. FIG. 7(A), FIG. 7(B) are schematic diagrams illustrating an embodiment of the pressure switch 600. FIG. 7(A) shows the situation that the pressure P of air to be supplied by the flexible tube 38 is not lower than the threshold Pth, and FIG. 7(B) shows the situation that the pressure P is lower than the threshold Pth. In this embodiment, the pressure switch 600 has a case 680, metal parts 610, 620, 630, and a pressure chamber 640. A portion of the first metal part 610, a portion of the second metal part 620, the third metal part, and the pressure chamber 680 are housed within the case 680.

Each of the first metal part 610 and the second metal part 620 is fixed to the case 680. The first metal part 610 has the first terminal Ta which is a portion exposed to the outside of the case 680. The second metal part 620 has the second terminal Tb which is a portion exposed to the outside of the case 680.

The pressure chamber 640 has a diaphragm 644. A connecting pipe 642 is connected to the pressure chamber 640. The flexible tube 38 is connected to the connecting pipe 642. The diaphragm 644 deforms toward a first direction D1 due to the pressure P. The deformation amount of the diaphragm 644 increases with the pressure P.

The third metal part 630 is connected to the diaphragm 644. The third metal part 630 can slide parallel to the first direction D1 according to the deformation amount of the diaphragm 644 while remaining in contact with the first metal part 610. The third metal part 630 also has a contact 632. The contact 632 is located in the first direction D1 of the second metal part 620.

When the pressure P is not lower than the threshold Pth (FIG. 7(A)), the deformation amount of the diaphragm 644 is larger. The location of the third metal part 630 is such that the contact 632 is away from the second metal part 620 in the first direction D1. As a result, the path between the terminals Ta, Tb is disconnected.

When the pressure P is lower than the threshold Pth (FIG. 7(B)), the deformation amount of the diaphragm 644 is smaller. The location of the third metal part 630 is such that the contact 632 is in contact with the second metal part 620. As a result, the terminals Ta, Tb is connected.

It should be noted that the threshold of pressure may be adjusted in any method. For example, the threshold may be adjusted by changing the stiffness (e.g. thickness) of the diaphragm 644.

As shown in FIG. 6, within the alarm device 200, the voltage line L, the neutral line N, and the grounding line GND of the first electric cord 34 are connected to the voltage line L, the neutral line N, and the grounding line GND of the second electric cord 36, respectively. The voltage line L and neutral line N of the second electric cord 36 supply electric power to the gas output device 130 (FIG. 3).

Within the alarm device 200, the following circuitry is formed between the voltage line L and the neutral line N. The first terminal T1 of the switch 700 is connected to the second terminal Tb of the pressure switch 600, the fifth terminal T5 of the switch 700, and a first terminal 991 of the lamp 990. The second terminal T2 is connected to the voltage line L. The third terminal T3 is connected to the first terminal Ta of the pressure switch 600. The fourth terminal T4 is connected to the first terminal 595 of the buzzer 500. The sixth terminal T6 is not in use. In addition, the second terminal 596 of the buzzer 500 and the second terminal of the lamp 990 are connected to the neutral line N.

### A10. Operation Modes:

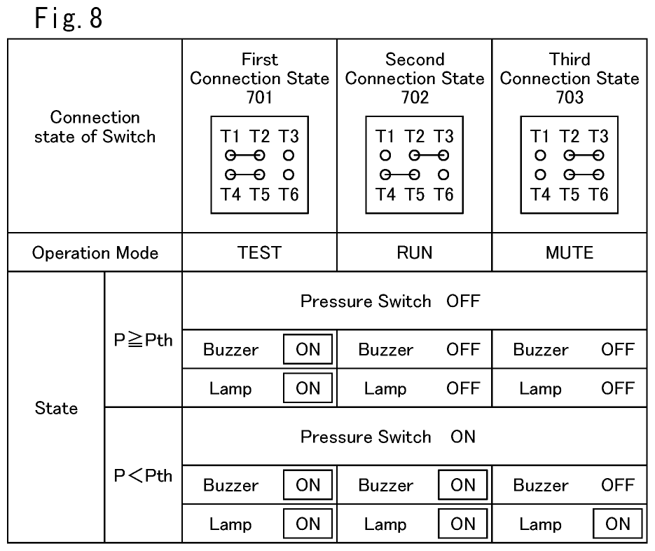

FIG. 8 is a table that shows correspondence relationships among the connection state of the switch 700, the operation mode of the alarm device 200, and the state of the alarm device 200. In this embodiment, the connection state of the switch 700 is selected from among three connection states 701-703. The first connection state 701 corresponds to a “test mode,” the second connection state 702 corresponds to a “run mode,” and the third connection state 703 corresponds to a “mute mode.” A worker can manipulate the switch 700 to select one mode from among the three modes.

In the first connection state 701 (test mode), the first terminal T1 and the second terminal T2 are connected, and the fourth terminal T4 and the fifth terminal T5 are connected. The voltage line L (FIG. 6) is connected via the terminals T1, T2 to the first terminal 991 of the lamp 990. In addition, the voltage line L is connected via the terminals T1, T2, T5, T4 to the first terminal 595 of the buzzer 500. Therefore, the buzzer 500 and the lamp 990 operate regardless of the pressure P. The test mode is a mode for testing the buzzer 500 and the lamp 990.

In the second connection state 702 (run mode), the second terminal T2 and the third terminal T3 are connected, and the fourth terminal T4 and the fifth terminal T5 are connected. The pressure switch 600 (FIG. 6) disconnects the path between the terminals Ta, Tb if the pressure is not lower than the threshold Pth. The voltage line L is disconnected from the buzzer 500 and the lamp 990. Therefore, the buzzer 500 and the lamp 990 are nonoperative. The pressure switch 600 connects the terminals Ta, Tb if the pressure P is lower than the threshold Pth. The voltage line L is connected via the terminals T2, T3, Ta, Tb to the first terminal 991 of the lamp 990. In addition, the voltage line L is connected via the terminals T2, T3, Ta, Tb, T5, T4 to the first terminal 595 of the buzzer 500. Therefore, the buzzer 500 and the lamp 990 are operative. In this manner, the pressure switch 600 switches the state of the buzzer 500 and the state of the lamp 990 between off-state (nonoperative state) and on-state (operative state), depending on the pressure P. The run mode is a mode for informing of a problem by using both of sound and light.

In the third connection state 703 (mute mode), the second terminal T2 and the third terminal T3 are connected, and the fifth terminal T5 and the sixth terminal T6 are connected. The pressure switch 600 (FIG. 6) disconnects the path between the terminals Ta, Tb if the pressure is not lower than the threshold Pth. The voltage line L is disconnected from the buzzer 500 and the lamp 990. Therefore, the buzzer 500 and the lamp 990 are nonoperative. The pressure switch 600 connects the terminals Ta, Tb if the pressure P is lower than the threshold Pth. The voltage line L is connected via the terminals T2, T3, Ta, Tb to the first terminal 991 of the lamp 990. However, the voltage line L is disconnected from the buzzer 500. Therefore, the buzzer 500 is nonoperative, but the lamp 990 is operative. The mute mode is a mode for informing of a problem by using light without sound.

The three operation modes are used, for example, as follows. In normal operation of the wastewater treatment system 10 (FIG. 1), the operation mode is set to the “run mode.” When the supply of air by the blower 30 does not have any problem, the pressure P is not lower than the threshold Pth, and the buzzer 500 and the lamp 990 do not operate. If the supply of air has a problem, the pressure P becomes lower than the threshold Pth. Then, the buzzer 500 and the lamp 990 operate. Although not shown, pump 100 (FIG. 3) has a switch that shuts off the electric power supply to the gas output device 130 in response to breakage of one or both of diaphragms 133d, 134d (such switch may be referred to as auto stopper). When one or both of the diaphragms 133d, 134d are broken, the auto stopper shuts off the electric power supply, and thus the gas output device 130 is stopped. As a result, the pressure P becomes lower than the threshold Pth. The auto stopper may have any configuration. When one or both of the diaphragms 133d, 134d are broken, the oscillator 132 oscillates at larger amplitude as compared with when both of the diaphragms 133d, 134d are not broken. The auto stopper is configured to shut off the connection between one or both of the voltage line L and neutral line N of the second electric cord 36 (FIG. 6) and the gas output device 130 by coming into contact with the oscillator 132 oscillating at the larger amplitude. It should be noted that the auto stopper may be omitted. Even in this case, gas leakage from a broken part of the diaphragms 133d, 134d can cause the pressure P to become lower than the threshold Pth.

The worker who manages the wastewater treatment system 10 can readily become aware of a problem through one or both of the light and the buzzer sound. The worker performs a task for resolving the problem (e.g. The worker repairs the connecting pipe 40, or replaces the damaged diaphragm (one or both of the diaphragms 133d, 134d (FIG. 3)). At this time, the worker may change the operation mode of the alarm device 200 to the “mute mode.” This allows the worker to proceed with the task in an environment without the buzzer sound. Even in this case, the worker can rely on the lamp 990 being off to confirm the resolution of the problem. After resolving the problem, the worker changes the operation mode of the alarm device 200 to the “run mode.”

### A11. Manufacturing Method:

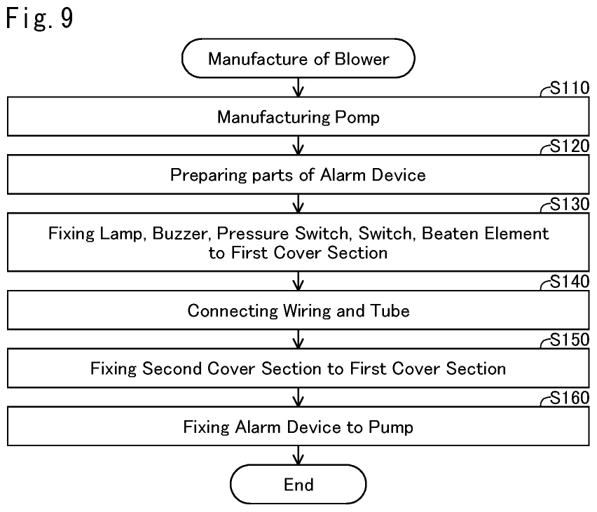

FIG. 9 is a flowchart showing an example manufacturing method of the blower 30. In S110, the pump 100 is manufactured. The pump 100 may be manufactured in any method. As described above, in this embodiment, the configuration of the pump 100 is the same as those of publicly known blowers without any alarm device, except that the flexible tube 38 is connected to the tank 135. Therefore, the pump 100 may be manufactured in the same manufacturing method as that of the publicly known blowers.

In S120, a plurality of parts of the alarm device 200 is prepared. Each of the plurality of parts may be manufactured in any method. The buzzer 500 is prepared, for example, by purchasing in the market a buzzer manufactured by a parts manufacturer. The pressure switch 600, the switch 700, the electric cords 34, 36, the flexible tube 38, the screws 313, 329, 359, 910 are similarly prepared by purchasing them in the market. The first cover section 300 is manufactured, for example, by forming with a mold (e.g. injection molding, blow molding, etc.). The second cover section 400 is manufactured, for example, by forging a metal plate.

In S130, the lamp 990, the buzzer 500, the pressure switch 600, the switch 700, and the screw 313 forming the second beaten element 315 are fixed to the first cover section 300. The lamp 990 is fixed using the nut for fixing as described above. As shown in FIG. 4(A), FIG. 4(B), the buzzer 500 is fixed by the screw 329, and the pressure switch 600 is fixed by the screw 359. The switch 700 is fixed using the nut for fixing as described above.

In S140, the flexible tube 38 is connected to the pressure switch 600. In addition, wiring is performed to form the electric circuit of FIG. 6. For example, the voltage line L of the first electric cord 34, the voltage line L of the second electric cord 36, and the second terminal T2 of the switch 700 are connected. The plurality of members (e.g. terminal and line) may be connected in any method (e.g. method of using coupling parts such as plug-in type connection terminal or screw, soldering, welding, etc.).

In S150, the second cover section 400 is fixed to the first cover section 300 (FIG. 3). In S160, the alarm device 200 is fixed to the pump 100. As described above, the blower 30 is manufactured.

It should be noted that the connection of the second electric cord 36 and the pump 100 and the connection of the flexible tube 38 and the pump 100 may each be made at any timing (e.g. in any of S110, S140, S160). In addition, the pump 100 and the alarm device 200 may be manufactured independently. For example, the pump 100 may be manufactured after the alarm device 200 is manufactured.

As described above, in this embodiment, the blower 30 (FIG. 3) has the pump 100 configured to output air, and the alarm device 200 fixed to the pump 100. The alarm device 200 has the buzzer 500, the lamp 990, the pressure switch 600, and the cover 210 fixed to the pump 100. As explained with regard to FIG. 8, the pressure switch 600 is an example control unit configured to control the buzzer 500 and the lamp 990 depending on the pressure P of gas to be output by the pump 100.

As explained with regard to FIG. 3, the cover 210 comprises a plurality of sections including the first cover section 300 and the second cover section 400. The cover 210 has the inner surfaces 380, 480 to form the internal space 389 surrounded by the inner surfaces 380, 480. The cover 210 houses the buzzer 500 and the pressure switch 600 within the internal space 389. The buzzer 500, the lamp 990, and the pressure switch 600 are fixed to the first cover section 300. Therefore, in S130 of the manufacturing method of FIG. 9, the buzzer 500, the lamp 990, and the pressure switch 600 are fixed to the same first cover section 300. If the buzzer 500, the lamp 990, and the pressure switch 600 were distributed between the first cover section 300 and the second cover section 400, it would be necessary to prepare for both fixing members to the first cover section 300 and fixing members to the second cover section 400 (e.g. A manufacturing line and tools for the both tasks would be prepared). As compared with this case, this embodiment reduces the complexity of manufacture of the blower 30 with the alarm device 200. Furthermore, in S140, the first cover section 300 and the second cover section 400 are not connected by wiring. If the first cover section 300 and the second cover section 400 were connected by wiring, the second cover section 400 connected to the first cover section 300 could prevent the screw from being tightened into the first cover section 300. In this embodiment, such a problem is avoided. In this manner, the complexity of manufacture of the blower 30 is reduced.

Furthermore, as shown in FIG. 5(A), FIG. 5(B), the buzzer 500 has the oscillator 580, the coil 570, and the first beaten element 519 configured to be beaten repeatedly by the oscillating oscillator 580 to produce the first buzzer sound. The coil 570 is an example of drive device configured to oscillate the oscillator 580. As shown in FIG. 5(C), FIG. 5(D), the alarm device 200 has the second beaten element 315 configured to be beaten repeatedly by the oscillating buzzer 500 (in this embodiment, the projection 512) to produce the second buzzer sound when the coil 570 oscillates the oscillator 580. Therefore, the alarm device 200 can produce a larger sound including the first buzzer sound and the second buzzer sound.

Furthermore, as shown in FIG. 5(C), FIG. 5(D), the alarm device 200 has the projection 310 projecting toward the buzzer 500. The projection 310 projects from the inner surface 380 of the cover 210 (in this case, the first cover section 300). Then, the end of the projection 310 forms the second beaten element 315. Therefore, the second beaten element 315 can be formed readily. For example, the second beaten element 315 is readily formed using the sound boss 311 and the screw 313.

The second beaten element 315 can deform due to the beat by the buzzer 500. In this embodiment, the end of the projection 310 forms the second beaten element 315. Therefore, even after the second beaten element 315 has deformed, the buzzer 500 beats the end of the projection 310 similarly to before the second beaten element 315 deforms. Therefore, the change in the second buzzer sound due to the deformation of the second beaten element 315 is reduced. For example, the possibility of the second buzzer sound becoming smaller is reduced.

The second beaten element 315 is the top surface 315 of the screw 313, and is formed by the screw 313. The screw 313 is an example of first forming element forming the second beaten element 315 (the screw 313 may be referred to as first forming element 313). The first forming element 313 is a member separate from the first cover section 300 (and thus the cover 210). As shown in FIG. 4(F), the first forming element 313 are fixed to the first cover section 300. Therefore, if the second beaten element 315 is damaged due to the repeated beat, the first forming element 313 can be replaced without replacing the cover 210.

As shown in FIG. 5(C) etc., the cover 210 (in this case, the first cover section 300) has the sound boss 311 forming the threaded hole 312. This threaded hole 312 is an example of recess provided on the internal space 389 side of the cover 210 (hereinafter, the threaded hole 312 may be referred to as recess 312, and the sound boss 311 may be referred to as recess forming element 311). The screw 313 includes a first portion 316 located within the threaded hole 312 and a second portion 317 exposed to the internal space 389. The second portion 317 forms the top surface 315 (i.e. second beaten element 315). In this embodiment, the second beaten element 315 is formed simply by threading the screw 313 into the threaded hole 312. Therefore, the complexity of manufacture of the blower 30 is reduced.

The recess 312 is not a through hole, but has a bottom. If the screw 313 were threaded into a hole passing through the side wall 370, a gap between the through hole and the screw 313 allows ingress of rainwater into the internal space 389. In this embodiment, such a problem is avoided.

The second beaten element 315 is the tip surface 315, and includes a flat outer surface. As shown in FIG. 5(C), FIG. 5(D), the buzzer 500 and the second beaten element 315 are arranged such that the buzzer 500 (in this case, the projection 512) beats the flat outer surface of the second beaten element 315. The location on the second beaten element 315 which comes into contact with the projection 512 can change among multiple beats. The change in contact location can be due to a variety of causes, including the deformation of the second beaten element 315, a change in location of the buzzer 500 relative to the first cover section 300 (e.g. rotation about the through hole 514), etc. The contact location can change randomly. The projection 512 is subject to a force from the second beaten element 315 when the projection 512 beats the second beaten element 315. If a curved outer surface were beaten by the projection 512, the direction of force which the projection 512 experiences from the curved outer surface could change randomly because the contact location changes randomly. The randomly changing force can cause the location of the buzzer 500 relative to the first cover section 300 to change significantly. In this embodiment, the change in location of the buzzer 500 is reduced because the flat top surface 315 is beaten by the projection 512 of the buzzer 500.

In the manufacture (FIG. 9) of the blower 30, the fixing the buzzer 500 to the first cover section 300 (S130) is performed with the projection 512 of the buzzer 500 (FIG. 5(A)) in contact with the flat second beaten element 315 of the screw 313. The location on the second beaten element 315 which comes into contact with the projection 512 can change randomly among multiple manufacturing processes of multiple blowers 30. The projection 512 is subject to a force from the second beaten element 315 when the screw 329 is tightened to fix the buzzer 500. If the projection 512 were in contact with a curved outer surface, the direction of force which the projection 512 experiences from the curved outer surface could change randomly because the contact location changes randomly. The randomly changing force can cause the location of the buzzer 500 relative to the first cover section 300 to be misaligned randomly. In this embodiment, the variation in location of the buzzers 500 among the multiple blowers 30 is reduced because the projection 512 of the buzzer 500 is in contact with the flat second beaten element 315.

As shown in FIG. 4(D), the buzzer 500 has the base member 510 with the through hole 514. As shown in FIG. 4(D), FIG. 4(E), the alarm device 200 has the screw 329. The screw 329 fixes the buzzer 500 to the cover 210 (in this case, the first cover section 300) by passing through the through hole 514 (the screw 329 may be referred to as fixing element 329). In this embodiment, the screw 329 is fixed to the first cover section 300 (specifically, the first fixing boss 321) with passing through the through hole 514. The outer diameter of the screw head if the screw 329 is larger than the inner diameter of the through hole 514. As shown in FIG. 4(B), FIG. 4(D), FIG. 4(E), the alarm device 200 has the wall 330 and the boss 340. In this embodiment, the wall 330 and the boss 340 are portions of the first cover section 300. As described above, the wall 330 and the boss 340 restrict the rotational position of the buzzer 500 about the through hole 514 by coming into contact with the buzzer 500 (hereinafter, the wall 330 may be referred to as first position restricting element, and the boss 340 may be referred to as second position restricting element 340). Therefore, the deviation of rotational position of the buzzer 500 is reduced.

The first position restricting element 330 restricts the rotational position of the buzzer 500 by coming into contact with the base member 510 of the buzzer 500. The base member 510 is a member that has the through hole 514 for fixing the buzzer 500. The first position restricting element 330 restricts the rotational position of the buzzer 500 properly as compared with when the first position restricting element 330 comes into contact with another member of the buzzer 500.

As shown in FIG. 3, the cover 210 (in this case, the first cover section 300) has the lower wall 309 which is a lower wall of the alarm device 200. The lower wall 309 has the thorough hole 305. The through hole 305 leads a buzzer sound produced in the cover 210 from the inside to the outside of the cover 210. Therefore, the alarm device 200 can output a larger sound. In addition, rainwater is less likely to enter the inside of the cover 210 through the through hole as compared with when the through hole 305 is formed on the upper wall 308 on the upward direction Z side of the cover 210 or on the wall on the lateral direction side.

### B. Second Embodiment

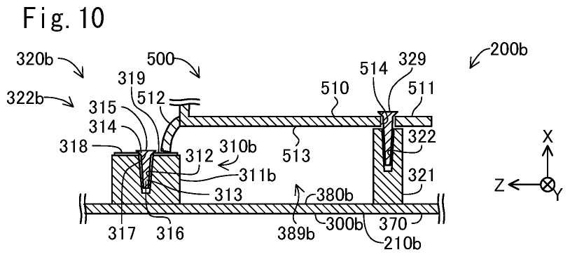

FIG. 10 is a schematic diagram showing another embodiment of alarm device. Similarly to FIG. 5(C), this figure shows cross-sectional views perpendicular to the second direction Y of a portion of an alarm device 200b including a portion of a first cover section 300b and a portion of the buzzer 500. The differences from the embodiment of FIG. 5(C) are the following three differences. The first difference is that an outer diameter of a sound boss 311b is larger than that of the sound boss 311 of FIG. 5(C). The second difference is that a disc-shaped washer 318 is disposed on the end surface on the +X direction side of the sound boss 311b, and the screw 313 fixes the washer 318 to the sound boss 311b. The third difference is that the projection 512 of the buzzer 500 is in contact with a flat outer surface 319 on the +X direction side of the washer 318 instead of the top surface 315 of the screw 313. The configurations of the other portions of the alarm device 200b in this embodiment are the same as those of the corresponding portions of the alarm device 200 described above. The alarm device 200b is formed using the first cover section 300b instead of the first cover section 300 (FIG. 3). The alarm device 200b has a cover 210b (FIG. 10) comprising the first cover section 300b and the second cover section 400 (FIG. 3). The cover 210b forms an internal space 389b surrounded by inner surfaces 380b, 480. The alarm device 200b is fixed to the pump 100, instead of the alarm device 200 (FIG. 3) of the first embodiment. The method of manufacturing a blower having the pump 100 and the alarm device 200b is the same as the manufacturing method (FIG. 9) of the first embodiment.

When the buzzer 500 operates, the projection 512 of the buzzer 500 beats repeatedly the flat outer surface 319 of the washer 318. This causes the second buzzer sound to be produced. Hereinafter, the outer surface 319 of the washer 318 may be referred to as second beaten element 319. In this embodiment, the change in location of the buzzer 500 is reduced similarly to the first embodiment because the flat outer surface 319 is beaten by the projection 512 of the buzzer 500.

The washer 318 is fixed to the sound boss 311b by the screw 313. The screw 313 and the washer 318 as a whole are an example of first forming element forming the second beaten element 319. Hereinafter, the screw 313 and the washer 318 may be collectively referred to as first forming element 320b. The first forming element 320b comprises the screw 313 and washer 318 which are members separate from the cover 210b. Therefore, if the second beaten element 319 is damaged due to the repeated beat, the washer 318 and thus the first forming element 320b can be replaced without replacing the cover 210b.

The first cover section 300b has the sound boss 311b forming the threaded hole 312. This threaded hole 312 is an example of recess provided on the internal space 389b side (hereinafter, the sound boss 311b may be referred to as recess forming element 311b). The first portion 316 of the screw 313 is located within the threaded hole 312. The screw head 314 of the screw 313, and the washer 318 are exposed to the internal space 389b (hereinafter, the screw head 314 and the washer 318 may be collectively referred to as second portion 322b). In this manner, the first forming element 320b includes the first portion 316 located within the threaded hole 312 and the second portion 322b exposed to the internal space 389b. The second portion 322b forms the second beaten element 319. In this embodiment, the second beaten element 319 is formed simply by threading the screw 313 through the washer 318 into the threaded hole 312. Therefore, the complexity of manufacture of the blower with the alarm device 200b is reduced.

The sound boss 311b, the screw 313, and the washer 318 collectively form a projection 310b projecting toward the buzzer 500. The projection 310b projects from the inner surface 380b of the first cover section 300b. The washer 318 is provided on the end of the projection 310b. That is, the end of the projection 310b forms the second beaten element 319. Therefore, the second beaten element 319 can be formed readily. For example, the second beaten element 319 is readily formed using the sound boss 311b, the screw 313, and the washer 318. In addition, the change in the second buzzer sound due to the deformation of the second beaten element 319 is reduced.

The configurations of portions other than the above differences in the alarm device 200b are the same as those of the corresponding portions of the alarm device 200 in the first embodiment. Therefore, the blower with the alarm device 200b of this embodiment has a variety of benefits similarly to the blower 30 of the first embodiment. For example, the buzzer 500 (FIG. 3), the lamp 990, and the pressure switch 600 are fixed to the first cover section 300b. Therefore, the complexity of manufacture of the blower 30 with the alarm device 200b is reduced.

### C. Third Embodiment

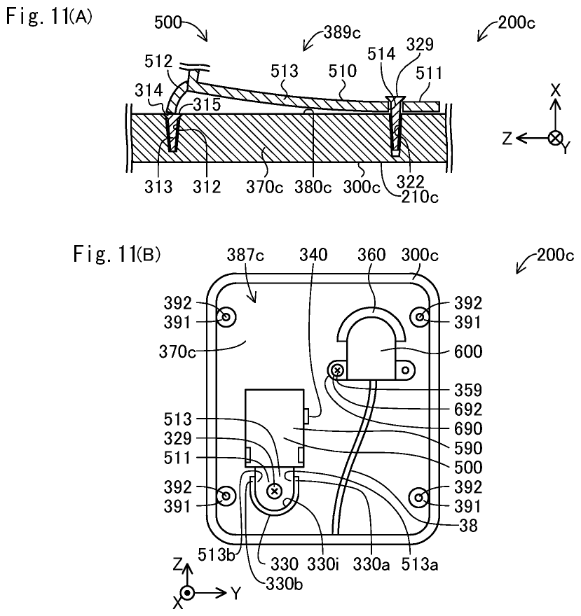

FIG. 11(A) is a schematic diagram showing another embodiment of alarm device. Similarly to FIG. 5(C), this figure shows cross-sectional views perpendicular to the second direction Y of a portion of an alarm device 200c including a portion of a first cover section 300c and a portion of the buzzer 500. The differences from the embodiment of FIG. 5(C) are the following two differences. The first difference is that a side wall 370c which is a wall on the −X direction side of the first cover section 300c is larger in thickness than the side wall 370. The second difference is that the sound boss 311 and the first fixing boss 321 are omitted, and the threaded holes 312, 322 are formed in the side wall 370c. The configurations of the other portions of the alarm device 200c in this embodiment are the same as those of the corresponding portions of the alarm device 200 described above. The alarm device 200c is formed using the first cover section 300c instead of the first cover section 300 (FIG. 3). The alarm device 200c has a cover 210c (FIG. 11(A)) comprising the first cover section 300c and the second cover section 400 (FIG. 3). The cover 210c forms an internal space 389c surrounded by inner surfaces 380c, 480. The alarm device 200c is fixed to the pump 100, instead of the alarm device 200 (FIG. 3) of the first embodiment. The method of manufacturing a blower having the pump 100 and the alarm device 200c is the same as the manufacturing method (FIG. 9) of the first embodiment.

In this embodiment, the buzzer 500 is fixed to the first cover section 300c by the single screw 329. The screw 329 is threaded in the threaded hole 322 with passing through the through hole 514 of the first portion 511 of the buzzer 500. The outer diameter of the screw head if the screw 329 is larger than the inner diameter of the through hole 514.

With the buzzer 500 fixed to the first cover section 300c, the projection 512 of the buzzer 500 is in contact with the flat top surface 315 of the screw head 314 of the screw 313. The screw 313 is threaded in the threaded hole 312. The top surface 315 of the screw 313 is exposed to the internal space 389c. It should be noted that the bosses 311, 321 are omitted unlike the embodiment of FIG. 5(C), FIG. 5(D). Therefore, with the buzzer 500 fixed to the first cover section 300c, the first base portion 513 can become curved.

When the buzzer 500 operates, the projection 512 of the buzzer 500 beats repeatedly the top surface 315 of the screw 313 similarly to the embodiment of FIG. 5(C), FIG. 5(D). This causes the second buzzer sound to be produced. In this embodiment, the top surface 315 is an example of second beaten element which the buzzer 500 beats repeatedly (the top surface 315 may be referred to as second beaten element 315). The screw 313 is an example of first forming element forming the second beaten element 315 (the screw 313 may be referred to as first forming element 313). The first forming element 313 is a member separate from the cover 210c. Therefore, if the second beaten element 315 is damaged due to the repeated beat, the first forming element 313 can be replaced without replacing the cover 210c.

The first cover section 300c has the side wall 370c forming the threaded hole 312. This threaded hole 312 is an example of recess provided on the internal space 389c side of the first cover section 300c (hereinafter, the threaded hole 312 may be referred to as recess 312, and the side wall 370c may be referred to as recess forming element 370c). In this embodiment, the top surface 315 of the screw 313 is exposed to the internal space 389c, and the other portion of the screw 313 is located within the threaded hole 312. The portion of the screw 313 that is exposed to the internal space 389c forms the top surface 315 (i.e. second beaten element 315). In this embodiment, the second beaten element 315 is formed simply by threading the screw 313 into the threaded hole 312. Therefore, the complexity of manufacture of the blower 30 is reduced.

FIG. 11(B) is a schematic diagram illustrating the configuration inside of a recess 387c of the first cover section 300c. This figure shows the first cover section 300c as viewed in the −X direction similarly to FIG. 4(B). Position restricting elements 330, 340 are formed on the side wall 370c of the first cover section 300c. The configurations of the position restricting elements 330, 340 are respectively the same as those of the position restricting elements 330, 340 described with regard to FIG. 4(B), FIG. 4(D), FIG. 4(E). Again in this embodiment, the position restricting elements 330, 340 restrict the rotational position of the buzzer 500 about the through hole 514 by coming into contact with the buzzer 500 similarly to the embodiment of FIG. 4(B), FIG. 4(D), FIG. 4(E).

It should be noted that in this embodiment, the first fixing boss 321 is omitted unlike the embodiment of FIG. 4(E). Therefore, the wall 330 of this embodiment may be lower in height than the wall 330 of FIG. 4(E).

The configurations of portions other than the above differences in the alarm device 200c are the same as those of the corresponding portions of the alarm device 200 in the first embodiment. Therefore, the blower with the alarm device 200c of this embodiment has a variety of benefits similarly to the blower 30 of the first embodiment. For example, the buzzer 500 (FIG. 11(B)), the pressure switch 600, and the lamp 990 (FIG. 3) are fixed to the first cover section 300c. Therefore, the complexity of manufacture of the blower 30 with the alarm device 200c is reduced.

### D. Fourth Embodiment

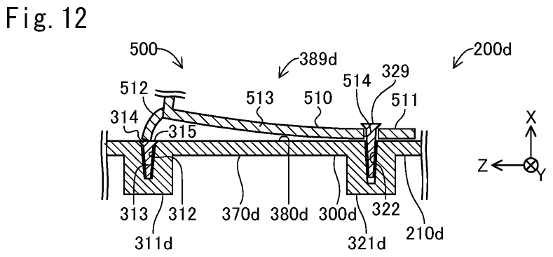

FIG. 12 is a schematic diagram showing another embodiment of alarm device. Similarly to FIG. 5(C), this figure shows cross-sectional views perpendicular to the second direction Y of a portion of an alarm device 200d including a portion of a first cover section 300d and a portion of the buzzer 500. The differences from the embodiment of FIG. 5(C) are the following two differences. The first difference is that a side wall 370d forms a first projection 311d projecting outward from the side wall 370d instead of the sound boss 311. The first projection 311d forms a threaded hole 312. The second difference is that the side wall 370d forms a second projection 321d projecting outward from the side wall 370d instead of the first fixing boss 321. The second projection 321d forms a threaded hole 322.

The configuration of inner surface 380d of the side wall 370d is the same as that of the inner surface 380c of the side wall 370c in FIG. 11(A). The configuration for fixing the buzzer 500 to the first cover section 300d is the same as that for fixing the buzzer 500 to the first cover section 300c in FIG. 11(A). The operation of buzzer 500 is the same as that of the buzzer 500 in FIG. 11(A).

The configurations of the other portions of the alarm device 200d in this embodiment are the same as those of the corresponding portions of the alarm device 200 described above. The alarm device 200d is formed using the first cover section 300d instead of the first cover section 300 (FIG. 3). The alarm device 200d has a cover 210d comprising the first cover section 300d and the second cover section 400 (FIG. 3). The cover 210d forms an internal space 389d surrounded by inner surfaces 380d, 480. The threaded hole 312 is an example of recess provided on the internal space 389d side of the cover 210d. The first projection 311d is an example of recess forming element that forms the threaded hole 312 (i.e. recess) (which may be referred to as recess forming element 311d). The top surface 315 of the screw 313 is exposed to the internal space 389d, and the other portion of the screw 313 is located within the threaded hole 312. The portion of the screw 313 that is exposed to the internal space 389d forms the top surface 315 (i.e. second beaten element 315). The alarm device 200d is fixed to the pump 100, instead of the alarm device 200 (FIG. 3) of the first embodiment. The method of manufacturing a blower having the pump 100 and the alarm device 200d is the same as the manufacturing method (FIG. 9) of the first embodiment.

### E. Modifications

(1) The configuration of the buzzer may be any configuration that includes an oscillator, a drive device configured to oscillate the oscillator, and a first beaten element configured to be beaten repeatedly by the oscillating oscillator to produce a first buzzer sound. For example, the drive device may be an electric motor or a piezoelectric element. The configuration of the oscillator may be any configuration that allows for oscillation. For example, the oscillator may be a rod having a fixed end and a free end. The free end of the rod can oscillate. Alternatively, the oscillator may be a film. The configuration of the first beaten element may be any configuration that allows it to be beaten by the oscillator. For example, the first beaten element may be a projection that projects toward the oscillator. The end of the projection may be beaten by the oscillator. The configuration for supporting the oscillator, the drive device, and the first beaten element is not limited to the configuration including the base member 510 in FIG. 5(A), and may be any configuration. For example, the case of the buzzer may support the oscillator, the drive device, and the first beaten element.

(2) The configuration for fixing the buzzer to the cover may be any configuration instead of the configuration (FIG. 4(E) etc.) that includes the screw 329 and the threaded hole 322. For example, a pin without male thread may be used instead of the screw 329, and a recess without female thread may be used instead of the threaded hole 322. Accordingly, the buzzer may be fixed to the cover by the pin being press-fitted into the recess of the cover, the pin passing through the through hole (e.g. the through hole 514 of FIG. 4(D)) of the buzzer. Alternatively, the buzzer may have a projection, and the cover may form a recess. Accordingly, the buzzer may be fixed to the cover by the projection of the buzzer being press-fitted into the recess of the cover. Alternatively, the buzzer may be fixed to the cover with an adhesive. Alternatively, the cover may have a boss, and the buzzer may have a recess. The buzzer may be fixed to the cover by the boss being press-fitted into the recess of the buzzer.

(3) The configuration of the second beaten element that is beaten by the buzzer is not limited to the top surface 315 of the screw 313 (FIG. 5(C)) or the outer surface 319 of the washer 318 (FIG. 10), and may be any configuration. For example, the alarm device may have a projection projecting toward the buzzer, and the projection may form the second beaten element. In this case, the projection may be formed integrally with the cover, or may comprise one or more members separate from the cover instead. The entire projection may be formed of a single member separate from the cover. For example, the projection may be a metal rod-shaped member. The projection may be fixed to the cover in any method. For example, a male thread of the projection may be threaded into a threaded hole of the cover. Alternatively, the projection may be fixed to the cover with an adhesive. It should be noted that the second beaten element may be configured without using any projection.

The second beaten element may be formed integrally with the cover (i.e. the second beaten element may be a part of the cover). Instead, the second beaten element may be formed by a first forming element separate from the cover. The first forming element may comprise three or more members separate from the cover.

If the second beaten element is formed by the first forming element, the first forming element may be a variety of screws different from a flat head screw. For example, the first forming element may be a screw with a curved top surface.

If the second beaten element is formed by the first forming element, the cover may have a recess forming element that forms a recess provided on the internal space side of the cover. Accordingly, at least part of the first forming element may be located within the recess. In this case, it is preferable that the recess forming element is formed of a resin. For example, one or more resins may be used that are selected from polyethylene, polypropylene, polystyrene, polyvinyl chloride, ABS resin, AS resin, polyethylene terephthalate, methacrylic resin, polyamide, polycarbonate, polybutylene terephthalate. The use of such a resin allows the recess to be formed readily. It should be noted that the recess forming element may comprise a member separate from the cover, or may be a part of the cover.

If the second beaten element is formed by the first forming element, the first forming element may be fixed to the cover in any method. For example, the first forming element may be a pin without male thread instead of the screw 313 (FIG. 5(C). Instead of the threaded hole 322, a recess without female thread may be formed in the cover. Accordingly, the pin may press-fitted into the recess. Alternatively, the first forming element may be fixed to the cover with an adhesive.

The second beaten element may include a curved outer surface. The buzzer may beat the curved outer surface of the second beaten element.

In any case, it is preferable that the second beaten element is made of iron or alloy containing iron (e.g. stainless steel, carbon steel, etc.). If the second beaten element is formed by the first forming element, it is preferable that a member forming the second beaten element among one or more members constituting the first forming element is made of iron or alloy containing iron. This configuration improves the durability of the second beaten element as compared with when the second beaten element is made of resin. In addition, the second beaten element can produce a larger second buzzer sound.

(4) The portion of the buzzer that beats the second beaten element is not limited to the projection (e.g. the projection 512 of FIG. 5(C)), and may be any portion. For example, a flat plate portion of the first base portion 513 may beat the second beaten element.

(5) The configuration of the position restricting element which restricts the rotational position of the buzzer about the through hole (e.g. the through hole 514 of FIG. 4(D)) of the buzzer may be any configuration that allows it to restrict the rotational position by coming into contact with the buzzer. For example, a boss in contact with the edge 513a of the first base portion 513 and a boss in contact with the edge 513b may be provided separately. Alternatively, the screw threaded in the cover may restrict the rotational position by coming into contact with the buzzer. It should be noted that the position restricting element may be omitted. For example, in each embodiment described above, one or both of the position restricting elements 330, 340 (FIG. 4(A)) may be omitted.

(6) The configuration of the control unit that controls the buzzer and the lamp may be any configuration that allows it to control the buzzer and the lamp depending on the pressure P of gas to be output by the pump. For example, the pressure switch 600 (FIG. 6) may connect the terminals Ta, Tb when the pressure P is not lower than the threshold Pth, and may disconnect the path between the terminals Ta, Tb when the pressure P is lower than the threshold Pth. In this case, the electric circuit (FIG. 6) is modified to be adapted to the operation of the pressure switch 600. The pressure switch may have a cylinder connected to the flexible tube 38, a piston located in the cylinder, a spring for applying a force to the piston, and a connection metal part connected to the piston. When the pressure P is lower than the threshold Pth, the piston is pushed by the spring to move, and the connection metal part electrically connects the terminals Ta, Tb. When the pressure P is not lower than the threshold Pth, the piston is moved in the opposite direction by air, and the connection metal part moves away from the terminals Ta, Tb. In this manner, the pressure switch may have a first member (piston, diaphragm 644 (FIG. 7(A), etc.) which moves or deforms depending on the pressure P, and a second member (connection metal part, third metal part 630 (FIG. 7(A), etc.) which changes the connection state between a plurality of terminals by being moved by the first member.

In addition, the control unit may have a pressure sensor that measures the pressure P, and an electric circuit that controls the buzzer and the lamp using signals from the pressure sensor. The pressure sensor may be a variety of sensors such as a sensor with a piezoelectric element which deforms depending on the pressure P.

In this manner, the control unit may have the pressure switch that operates depending on the pressure, or the pressure sensor that measures the pressure. In any case, it is preferable that the control unit sets the state of the buzzer and the state of the lamp to the nonoperative state when the pressure P is not lower than the predetermined threshold Pth, and sets the state of the buzzer and the state of the lamp to the operative state when the pressure P is lower than the threshold Pth.

(7) The configuration of the cover of the alarm device may be any configuration that allows it to surround at least part of the alarm device. The first cover sections 300, 300b, 300c, 300d may be made of a variety of resins similarly to the recess forming element described above. Alternatively, the first cover sections 300, 300b, 300c, 300d may be made of a metal instead of a resin. The second cover section 400 may be made of a resin instead of a metal. The cover may comprise three or more sections. In addition, the through hole 305 (FIG. 3) may be omitted from the first cover sections 300, 300b, 300c, 300d.

In addition, the electric circuit of the alarm device may be waterproofed. In this case, the cover may surround only a portion of the alarm device. For example, in each embodiment described above, the second cover section 400 may be omitted, and the first cover sections 300, 300b, 300c, 300d may be fixed to the pump 100. In addition, the through hole 305 may be formed in the upper wall 308 or the side wall of the cover.

(8) The configuration of the alarm device may be a variety of configurations that allows it to inform of a problem on gas supply. The configuration of the electric circuit may be a variety of other configurations instead of the configuration of FIG. 6. For example, the electric plug 32, the electric cord 34, 36, and the pump 100 may be configured to use another type of electric power supply (e.g. three-phase power supply, DC power supply, etc.) instead of the single-phase AC power supply. In addition, the operation mode of the alarm device may be selected from one or more modes, including a mode (e.g. the run mode of FIG. 8) that allows the buzzer to inform of a problem. One or both of the test mode and the mute mode may be omitted. If only a single operation mode is available, the switch 700 may be omitted. In addition, the lamp 990 (FIG. 2(A)) may be omitted.

(9) The configuration of the pump may be any configuration that allows it to output oxygen-containing gas. For example, the pump has any device that suction, compress, and output the gas. For example, a device with cylinder and piston, or a device with cylinder and rotor may be employed as such a device. In addition, the gas to be output by the pump may be any gas that contains oxygen. For example, the pump may output oxygen gas supplied from an oxygen tank. In any case, it is preferable that a tube (e.g. the flexible tube 38 (FIG. 3)) in communication with the discharge outlet of the pump is connected to the control unit such as the pressure switch 600. The tube connected to the control unit may be in communication with the discharge outlet 190 within the pump 100 as in the embodiment of FIG. 3. Instead, the tube connected to the control unit may be in communication with the discharge outlet outside of the pump.

(10) The configuration of the wastewater treatment apparatus may be any configuration including a device that operates using oxygen-containing gas. The blower supplies such a device with the gas.

The present invention has been described above with reference to the embodiments and the modifications although the above-described embodiments are intended to facilitate the understanding of the invention, but not to limit the invention. The present invention may be modified or improved without departing from the spirit of the invention, and includes its equivalents.

### INDUSTRIAL APPLICABILITY

The present invention can be preferably used for blowers.

### REFERENCE SIGNS LIST

10 wastewater treatment system
20 wastewater treatment apparatus
30 blower
32 electric plug
34 first electric cord
36 second electric cord
38 flexible tube
40 connecting pipe
90 ground
100 pump
110 case
120 cover
130 gas output device
131 solenoid
132 oscillator
133, 134 pressure chamber
133d, 134d diaphragm
133i, 134i air intake valve
1330, 1340 discharge valve
135 tank
139 air inlet
180 connecting port
190 discharge outlet
200, 200b, 200c, 200d alarm device
210, 210b, 210c, 210d cover
300, 300b, 300c, 300d first cover section
308 upper wall
309 lower wall
311d first projection (recess forming element
321d second projection
370, 370d side wall
370c side wall ((recess forming element)
301 first through hole
302 second through hole
303 third through hole
304 fourth through hole
305 through hole
306 through hole
310, 310b projection
311 sound boss (recess forming element)
311b sound boss (recess forming element)
312 threaded hole (recess)
313 screw (first forming element)
314 screw head
315 top surface (second beaten element)
316 first portion
317 second portion
318 washer
319 outer surface (second beaten element)
320b first forming element
321 first fixing boss
322 threaded hole
322b second portion
329 screw (fixing element)
330 wall (first position restricting element)
339 plate
340 boss (second position restricting element)
351 second fixing boss
352 threaded hole
359 screw
360 wall
370 wall
380, 380b, 380c, 380d inner surface
387, 387c recess
388 opening
389, 389b, 389c, 389d internal space
391 third fixing boss
392 threaded hole
400 second cover section
410 plate
420 leg
421 first portion
422 second portion
423 through hole
480 inner surface
490 through hole
500 buzzer
510 base member
511 end (first portion)
512 projection
513 first base portion
514 through hole
517 second base portion
518 through hole
519 first beaten element (third base portion)
560 flat spring
570 coil
580 oscillator
581 first portion
582 second portion
590 case
595 first terminal
596 second terminal
600 pressure switch
610 first metal part
620 second metal part
630 third metal part
632 contact
640 pressure chamber
642 connecting pipe
644 diaphragm
680 case
690 projection
692 through hole
700 switch
701 first connection state
702 second connection state
703 third connection state
910, 920 screw
990 lamp
991 first terminal
992 second terminal
L voltage line
N neutral line
GND grounding line
T1-T6, Ta, Tb terminal
P pressure
Pth threshold

1. A blower for wastewater treatment apparatus comprising:
a pump configured to output oxygen-containing gas; and
an alarm device fixed to the pump, wherein
the alarm device has:
a buzzer;
a lamp;
a control unit configured to control the buzzer and the lamp depending on a pressure of gas to be output by the pump; and
a cover fixed to the pump,
the cover has an inner surface to form an internal space surrounded by the inner surface,
the cover houses the buzzer and the control unit within the internal space,
the cover comprises a plurality of sections including a first cover section and a second cover section, and
the buzzer, the lamp, and the control unit are fixed to the first cover section.

2. The blower of claim 1, wherein
the buzzer has:
an oscillator;
a drive device configured to oscillate the oscillator; and
a first beaten element configured to be beaten repeatedly by the oscillating oscillator to produce a first buzzer sound,
the alarm device has a second beaten element configured to be beaten repeatedly by the oscillating buzzer to produce a second buzzer sound when the drive device oscillates the oscillator.

3. The blower of claim 2, wherein
the alarm device has a projection projecting toward the buzzer, and
an end of the projection forms the second beaten element.

4. The blower of claim 2, wherein
the alarm device has a first forming element forming the second beaten element,
the first forming element comprises one or more members separate from the cover, and
the first forming element is fixed to the cover.

5. The blower of claim 4, wherein
the cover has a recess forming element that forms a recess provided on the internal space side of the cover,
the first forming element includes a first portion located within the recess and a second portion exposed to the internal space, and
the second portion forms the second beaten element.

6. The blower of claim 2, wherein
the second beaten element includes a flat outer surface, and
the buzzer and the second beaten element are arranged such that the buzzer beats the flat outer surface of the second beaten element.

7. The blower of claim 1, wherein
the buzzer has a first member with a through hole, and
the alarm device has:
a fixing element that fixes the buzzer to the cover by passing through the through hole of the first member; and
a position restricting element that restricts a rotational position of the buzzer about the through hole by coming contact with the buzzer.

8. The blower of claim 7, wherein
the position restricting element restricts the rotational position of the buzzer by coming into contact with the first member of the buzzer.

9. The blower of claim 1, wherein
the cover has a lower wall which is a lower wall of the alarm device, and
the lower wall has a thorough hole.

10. The blower of claim 2, wherein
the buzzer has a first member with a through hole, and
the alarm device has:
a fixing element that fixes the buzzer to the cover by passing through the through hole of the first member; and
a position restricting element that restricts a rotational position of the buzzer about the through hole by coming contact with the buzzer.

11. The blower of claim 4, wherein
the buzzer has a first member with a through hole, and
the alarm device has:
a fixing element that fixes the buzzer to the cover by passing through the through hole of the first member; and
a position restricting element that restricts a rotational position of the buzzer about the through hole by coming contact with the buzzer.

12. The blower of claim 5, wherein
the buzzer has a first member with a through hole, and
the alarm device has:
a fixing element that fixes the buzzer to the cover by passing through the through hole of the first member; and
a position restricting element that restricts a rotational position of the buzzer about the through hole by coming contact with the buzzer.

13. The blower of claim 2, wherein
the cover has a lower wall which is a lower wall of the alarm device, and
the lower wall has a thorough hole.

14. The blower of claim 4, wherein
the cover has a lower wall which is a lower wall of the alarm device, and
the lower wall has a thorough hole.

15. The blower of claim 5, wherein
the cover has a lower wall which is a lower wall of the alarm device, and
the lower wall has a thorough hole.

16. The blower of claim 10, wherein
the cover has a lower wall which is a lower wall of the alarm device, and
the lower wall has a thorough hole.

17. The blower of claim 11, wherein
the cover has a lower wall which is a lower wall of the alarm device, and
the lower wall has a thorough hole.

18. The blower of claim 12, wherein
the cover has a lower wall which is a lower wall of the alarm device, and
the lower wall has a thorough hole.
